(19) United States
(12) Patent Application Publication
(10) Pub. No.: US 2016/0355423 A1
(43) Pub. Date: Dec. 8, 2016

(54) OZONE FAUCET SWITCHING STRUCTURE

(71) Applicants: Hsu-Ying Liu, Changhua (TW); Tsair-Rong Chen, Changhua (TW)

(72) Inventors: Hsu-Ying Liu, Changhua (TW); Tsair-Rong Chen, Changhua (TW)

(73) Assignees: GEANN INDUSTRIAL CO., LTD., CHANGHUA (TW); Department of Electrical Engineering, National Changhua University of Education, CHANGHUA (TW)

(21) Appl. No.: 15/243,399

(22) Filed: Aug. 22, 2016

Related U.S. Application Data
(63) Continuation-in-part of application No. 14/299,049, filed on Jun. 9, 2014.

(51) Int. Cl. C02F 1/78; E03C 1/04; F16K 15/02; E03C 1/084

(52) U.S. Cl. CPC C02F 1/78; E03C 1/084; E03C 1/0404; F16K 15/026; E03C 2201/40; C02F 2303/04; C02F 2307/06; C02F 2305/02; C02F 2201/005; C02F 2201/004; C02F 2201/78

(57) ABSTRACT

A faucet apparatus with an ozonizer may comprise a faucet, a connecting unit, a bubbler and a control sleeve. An outer surface of the connecting unit has at least a first annular groove, and an elastic ring is disposed in the first annular groove. A first threaded segment is formed at a lower end of the connecting unit, and a bore penetrating through the outer surface of the connecting unit is located between the elastic ring and the first threaded segment. By turning the control sleeve to adjust the relative positions between the control sleeve and the connecting unit, the present invention is configured to prevent the control sleeve from being moved by water flow or airflow and to accurately control the use of the ozone thus improving the practicability thereof.

### CROSS-REFERENCE TO RELATED APPLICATIONS

This application is a continuous-in-part (CIP) application of Ser. No. 14/299,049, filed on Jun. 9, 2014, now pending, which is incorporated herein by reference.

### FIELD OF THE INVENTION

The present invention relates to a faucet apparatus with an ozonizer, and more particularly to an ozone faucet switching structure.

### BACKGROUND OF THE INVENTION

Nowadays, for agriculture, the farmer usually uses a large number of pesticides to protect crops from pests that leads to serious pollution to the environment. As a result, our daily vegetables need to wash for many times which wastes water, and further hazardous substances may not be removed completely which increases the risk in food safety. Because of high-activity, ozone (O₃) can be perfectly dissolved into water to achieve the effect of sterilization, disinfection, refreshment and deodorization, and also there is no by-product will be generated in water when ozone is used. Thus, a faucet with an ozonizer seems a necessary device for kitchen. Generally, referring to FIG. 8, a conventional faucet with an ozonizer comprises a faucet (50) which has a main body (51), and a handle (52) protrudes therefrom. The main body (51) is further connected to a guiding tube (53) which is settled inside an interior space of the main body (51). A first end of the guiding tube (53) is connected to a water outlet end (54) of the faucet (50) while a second end thereof is connected to an ozonizer. The handle (52) is configured to control on/off operation of ozone to mix with water in the faucet (50) to achieve the effect of sterilization.

However, the conventional faucet apparatus with an ozonizer has following disadvantages: (i) it may be misused when a user needs drinking water; (ii) the ozonizer always is installed under a kitchen sink which is inconvenient for operation; and (iii) although the ozonizer is switched off, there may still have a trace of ozone remained in the guiding tube (53) which causes issues of drinking water. Therefore, there remains a need for a new and improved design for a faucet apparatus with an ozonizer to overcome the problems presented above.

### SUMMARY OF THE INVENTION

The present invention provides a faucet apparatus with an ozonizer which comprises a faucet, a connecting unit, a bubbler and a control sleeve. The faucet has a water outlet tube, and a guiding tube is settled inside an interior space of the faucet. Also, a first end of the guiding tube is connected to an ozonizer. An upper end of the connecting unit comprises a fixing portion, and a first threaded segment is formed at a lower end of the connecting unit. Moreover, a through hole vertically penetrates through an inner edge of the fixing portion of the connecting unit, and the connecting unit is connected to the water outlet tube through the fixing portion to communicate the guiding tube with the first through hole. A locating annular groove is formed at a lower end of the first threaded segment, and a C-shaped engaging unit is secured in the locating annular groove. Furthermore, an upper opening and a lower opening which are communicated with each other vertically penetrate through the connecting unit. Also, the through hole is communicated with the upper opening, and an inner wall of the upper opening has at least a vertical vent which is extended downwardly toward an inner wall of the lower opening. In addition, the vent is communicated with a bore which penetrates though the outer surface of the connecting unit. Also, the outer surface of the connecting unit further comprises at least a first annular groove located near the bore, and an elastic ring is disposed in the first annular groove. The bore of the connecting unit is located between the elastic ring and the first threaded segment, and a sealing ring is disposed on the outer surface of the connecting unit between the bore and the first threaded segment. The bubbler is secured on the upper opening of the connecting unit, and a top surface of the bubbler is communicated with the water outlet tube of the faucet through a plurality of pores which are configured to produce a splashing stream of water. Furthermore, a plurality of lateral openings penetrate through a lateral surface of the bubbler such that the through hole, the vent, the upper opening, the pores and the lower opening are communicated with each other. The control sleeve covers around an outer periphery of the lower opening of the connecting unit, and a first surface formed at an upper portion of an inner surface of the control sleeve is borne against the elastic ring to create an air-tight seal. Furthermore, a second threaded segment formed at a lower portion of the inner surface of the control sleeve is configured to engage with the first threaded segment of the control unit to adjust a position of the control sleeve. Also, a second surface formed at a middle portion of the inner surface of the control sleeve is located between the first surface and the second threaded segment, and the sealing ring is borne against the second surface to achieve an air-tight effect.

In one embodiment, at least a plane venting surface is formed on the first threaded segment of the connecting unit to allow a large amount of air to enter the vent through a space between the venting surface and the control sleeve.

In another embodiment, a check valve connected between the through hole of the connecting unit and the guiding tube is configured to allow fluid to flow through the check valve in only one direction.

In still another embodiment, the check valve comprises a valve tube, a valve core and a valve pocket, and an upper end of the valve tube is connected to the guiding tube while a lower end thereof is connected to the valve pocket. Moreover, a flowing channel formed inside the valve pocket is communicated with the valve tube and the through hole, and the valve core coupled inside the valve tube is configured to allow fluid to flow in one direction.

In a further embodiment, the check valve comprises a valve base, a second valve core and a second valve pocket. An upper end of the valve base is connected to the guiding tube while a lower end thereof is borne against the bubbler, and a central hole penetrates through the valve base. Also, an interior space of the valve base has a second flowing channel which is communicated with the through hole of the connecting unit. The second valve core is received in the central hole of the valve base, and the second valve pocket couples on the central hole to limit a position of the second valve core. Through the second valve core, the check valve is configured to allow fluid to flow in the second flowing channel in only one direction.

Comparing with conventional faucet with an ozonizer, the present invention is advantageous because: the bore of the connecting unit is located between the elastic ring and the first threaded segment, and at least one plane venting surface is formed on the first threaded segment. When a user only needs tap water, the control sleeve is turned to move away from the connecting unit, and the air flows between the connecting unit and the control sleeve into the vent thus replacing the ozone to mix with water. Moreover, the control sleeve is connected with the connecting unit by engaging the second threaded segment with the first threaded segment. By turning the control sleeve to adjust the relative positions between the control sleeve and the connecting unit, the present invention can prevent the control sleeve from being moved by water flow or airflow and can accurately control the use of the ozone thus improving the practicability thereof.

### BRIEF DESCRIPTION OF THE DRAWINGS

FIG. 1 is a three-dimensional assembly view of a faucet apparatus with an ozonizer in the present invention.

FIG. 2 is a three-dimensional exploded view of the faucet apparatus with an ozonizer in the present invention.

FIG. 3 is a schematic view of the faucet apparatus with an ozonizer in the present invention when in use.

FIG. 4 is a sectional view of the faucet apparatus with an ozonizer in the present invention when the ozone from an ozonizer is applied.

FIG. 5 is another sectional view of the faucet apparatus with an ozonizer in the present invention when the ozone from the ozonizer is applied.

FIG. 6 is the third sectional view of the faucet apparatus with an ozonizer in the present invention when the ozone from the ozonizer is applied.

FIG. 7 is a sectional view of another embodiment of the faucet apparatus with an ozonizer in the present invention.

FIG. 8 is a prior art.

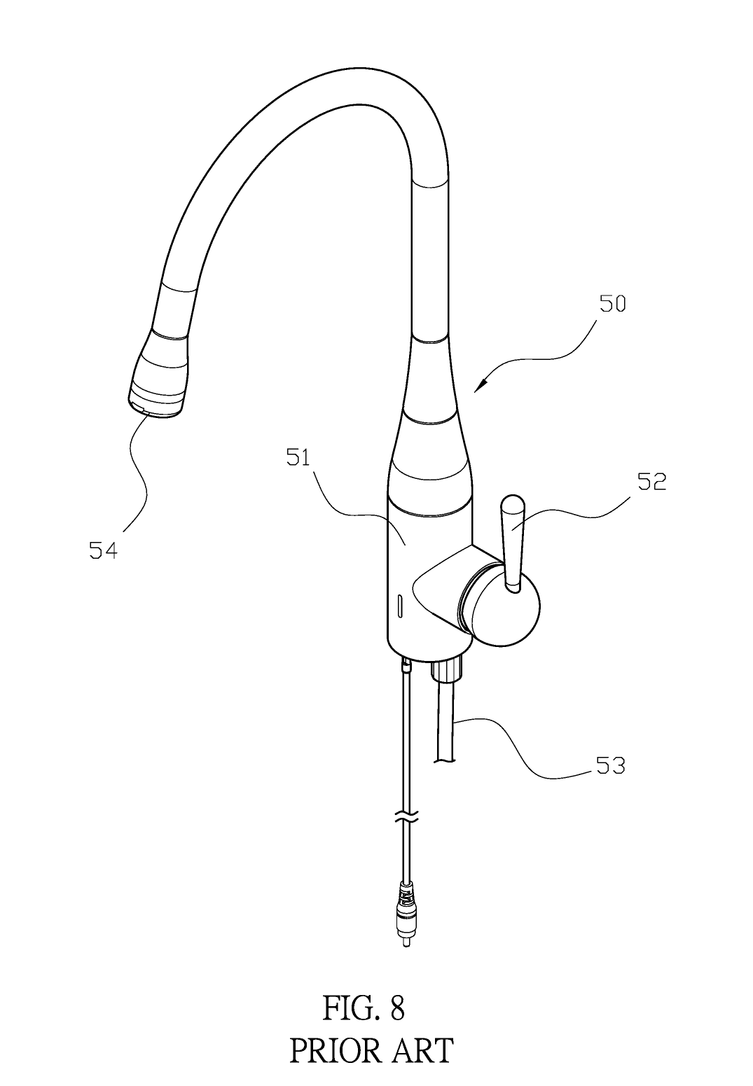

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

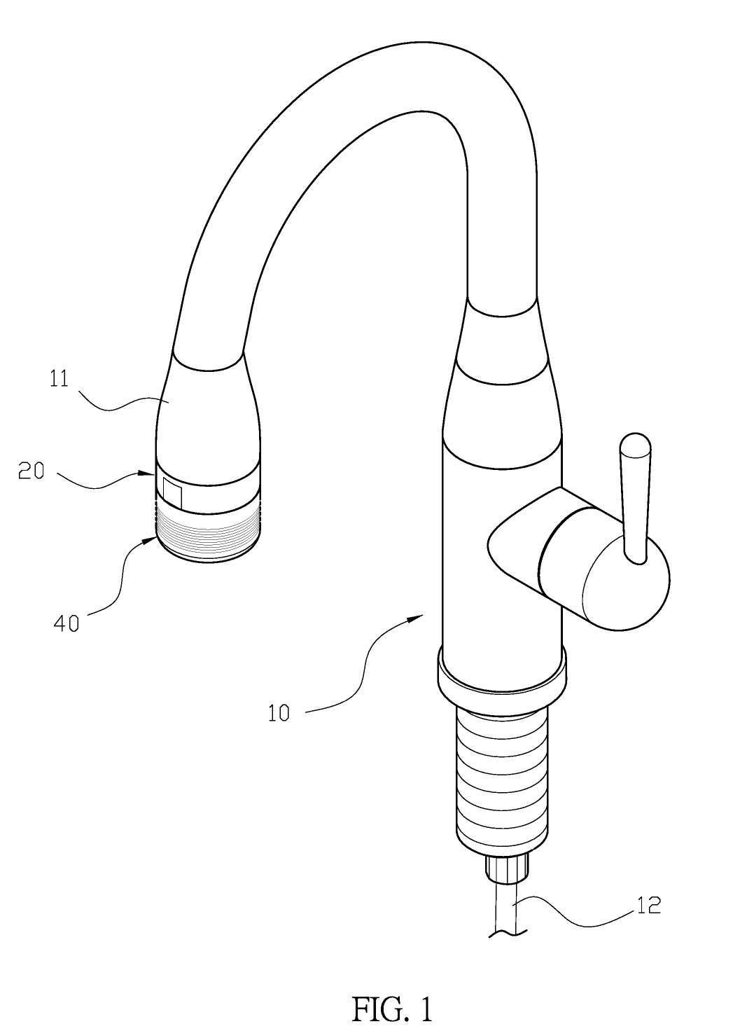

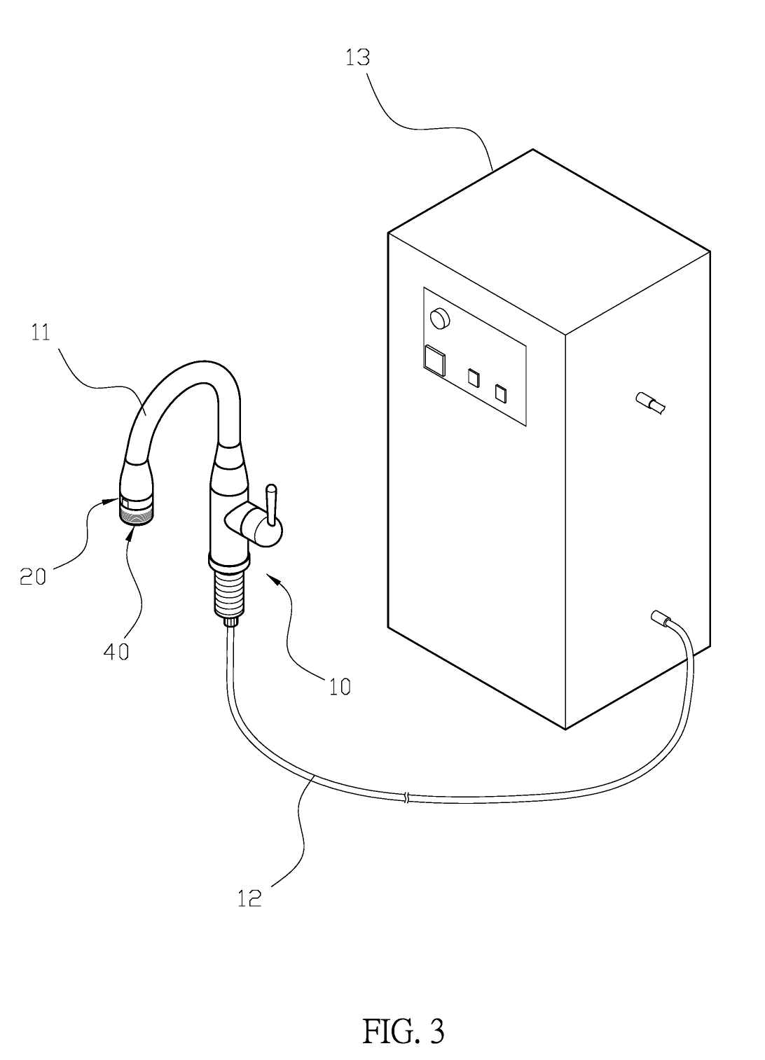

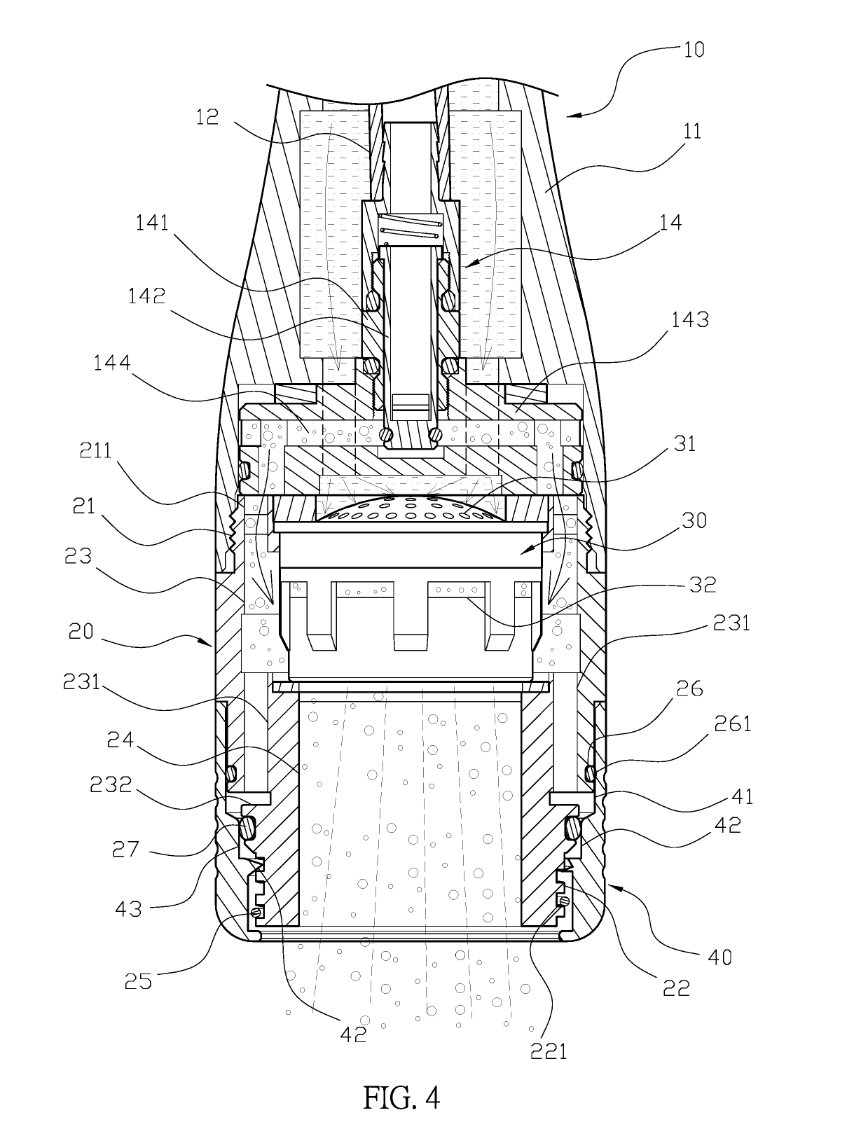

Referring to FIGS. 1 to 4, the present invention provides a faucet apparatus with an ozonizer which comprises a faucet (10), a connecting unit (20), a bubbler (30) and a control sleeve (40). The faucet (10) has a water outlet tube (11), and a guiding tube (12) is settled inside an interior space of the faucet (10). Also, a first end of the guiding tube (12) is connected to an ozonizer (13). An upper end of the connecting unit (20) comprises a fixing portion (21), and a first threaded segment (22) is formed at a lower end of the connecting unit (20). Moreover, a through hole (211) vertically penetrates through an inner edge of the fixing portion (21) of the connecting unit (20), and the connecting unit (20) is connected to the water outlet tube (11) through the fixing portion (21) to communicate the guiding tube (12) with the first through hole (211). A locating annular groove (221) is formed at a lower end of the first threaded segment (22), and a C-shaped engaging unit (25) is secured in the locating annular groove (221). Furthermore, an upper opening (23) and a lower opening (24) which are communicated with each other vertically penetrate through the connecting unit (20). Also, the through hole (211) is communicated with the upper opening (23), and an inner wall of the upper opening (23) has at least a vertical vent (231) which is extended downwardly toward an inner wall of the lower opening (24). In addition, the vent (231) is communicated with a bore (232) which penetrates though the outer surface of the connecting unit (20). Also, the outer surface of the connecting unit (20) further comprises at least a first annular groove (26) located near the bore (232), and an elastic ring (261) is disposed in the first annular groove (26). The bore (232) of the connecting unit (20) is located between the elastic ring (261) and the first threaded segment (22), and a sealing ring (27) is disposed on the outer surface of the connecting unit (20) between the bore (232) and the first threaded segment (22). A check valve (14) connected between the through hole (211) of the connecting unit (20) and the guiding tube (12) is configured to allow fluid to flow through the check valve (14) in only one direction. Also, the check valve (14) comprises a valve tube (141), a valve core (142) and a valve pocket (143), and an upper end of the valve tube (141) is connected to the guiding tube (12) while a lower end thereof is connected to the valve pocket (143). Moreover, a flowing channel (144) formed inside the valve pocket (143) is communicated with the valve tube (141) and the through hole (211), and the valve core (142) coupled inside the valve tube (141) is configured to allow fluid to flow in one direction. The bubbler (30) is secured on the upper opening (23) of the connecting unit (20), and a top surface of the bubbler (30) is communicated with the water outlet tube (11) of the faucet (10) through a plurality of pores (31) which are configured to produce a splashing stream of water. Furthermore, a plurality of lateral openings (32) penetrate through a lateral surface of the bubbler (30) such that the through hole (211), the vent (231), the upper opening (23), the pores (31) and the lower opening (24) are communicated with each other. The control sleeve (40) covers around an outer periphery of the lower opening (24) of the connecting unit (20), and a first surface (41) formed at an upper portion of an inner surface of the control sleeve (40) is borne against the elastic ring (261) to create an air-tight seal. Furthermore, a second threaded segment (42) formed at a lower portion of the inner surface of the control sleeve (40) is configured to engage with the first threaded segment (22) of the control unit (20) to adjust a position of the control sleeve (40). Also, a second surface (43) formed at a middle portion of the inner surface of the control sleeve (40) is located between the first surface (41) and the second threaded segment (42), and the sealing ring (27) is borne against the second surface (43) to achieve an air-tight effect. Additionally, at least a plane venting surface (222) is formed on the first threaded segment (22) of the connecting unit (20) to allow a large amount of air to enter the vent (231) through a space between the venting surface (222) and the control sleeve (40).

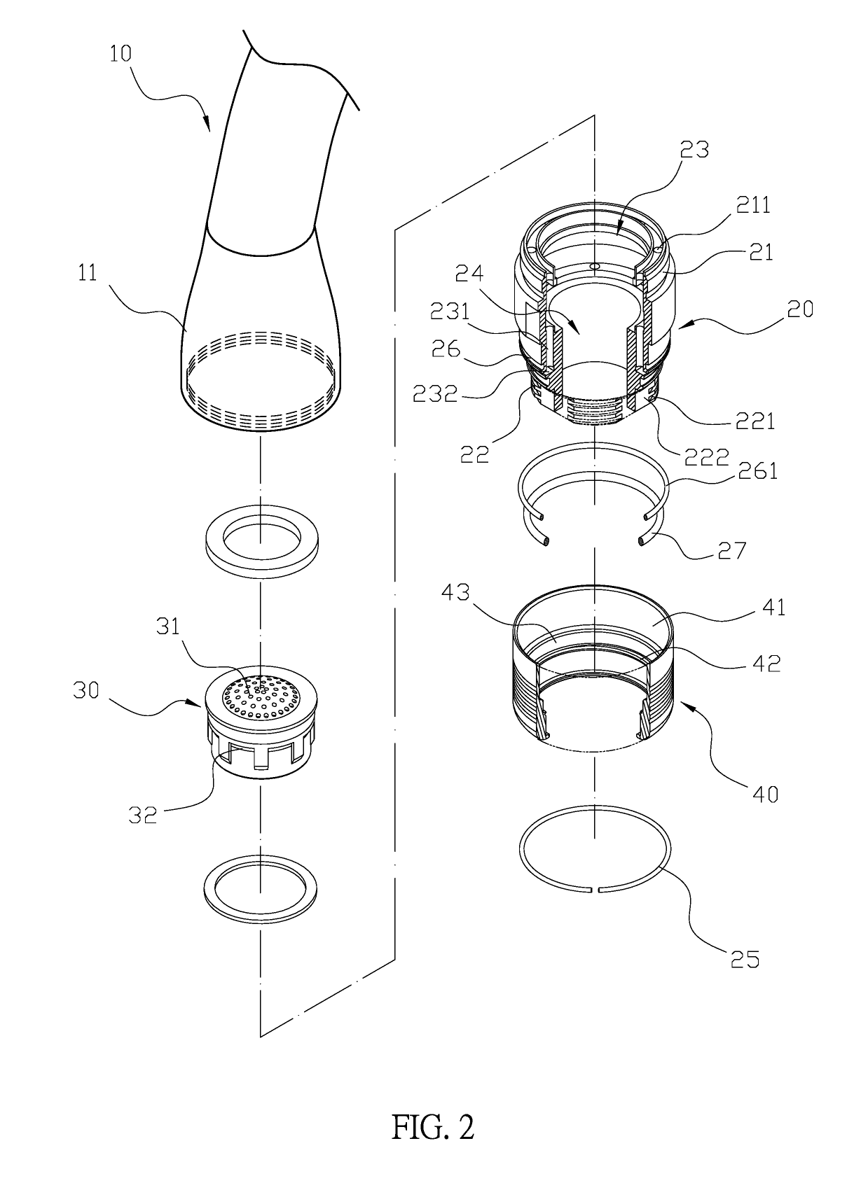

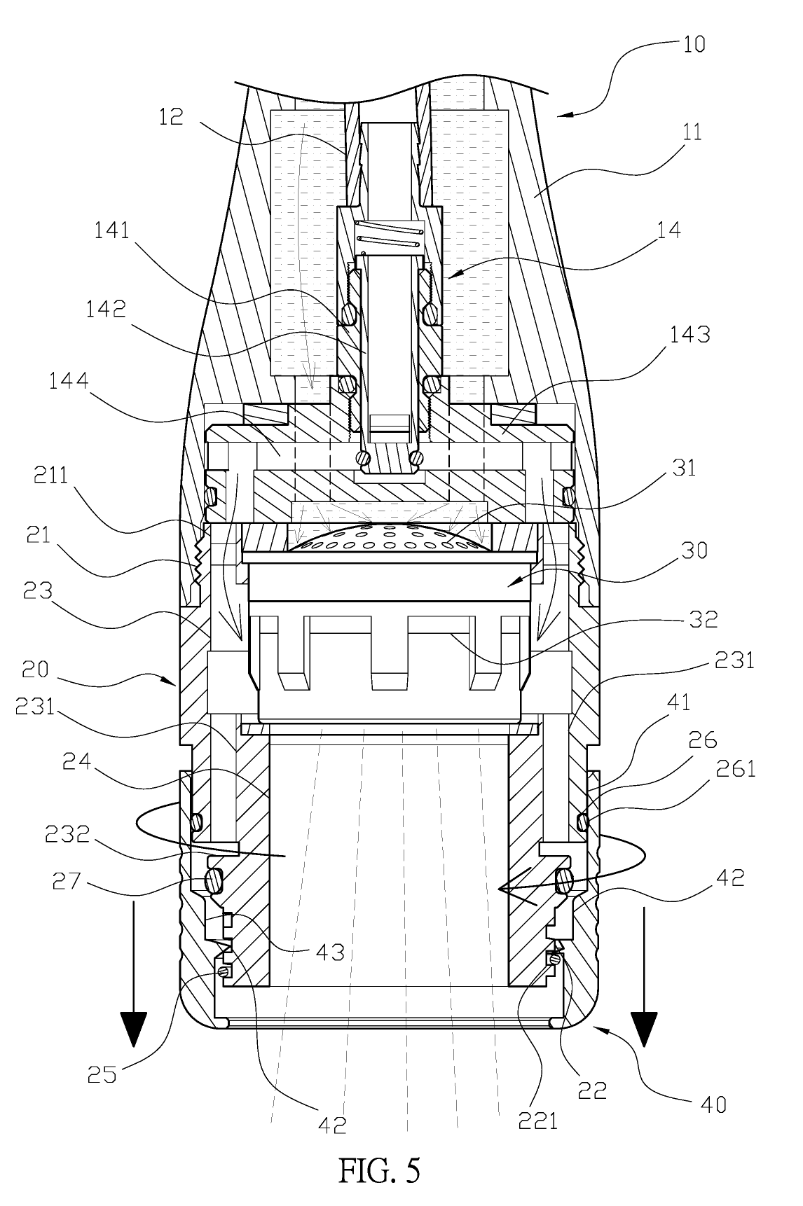

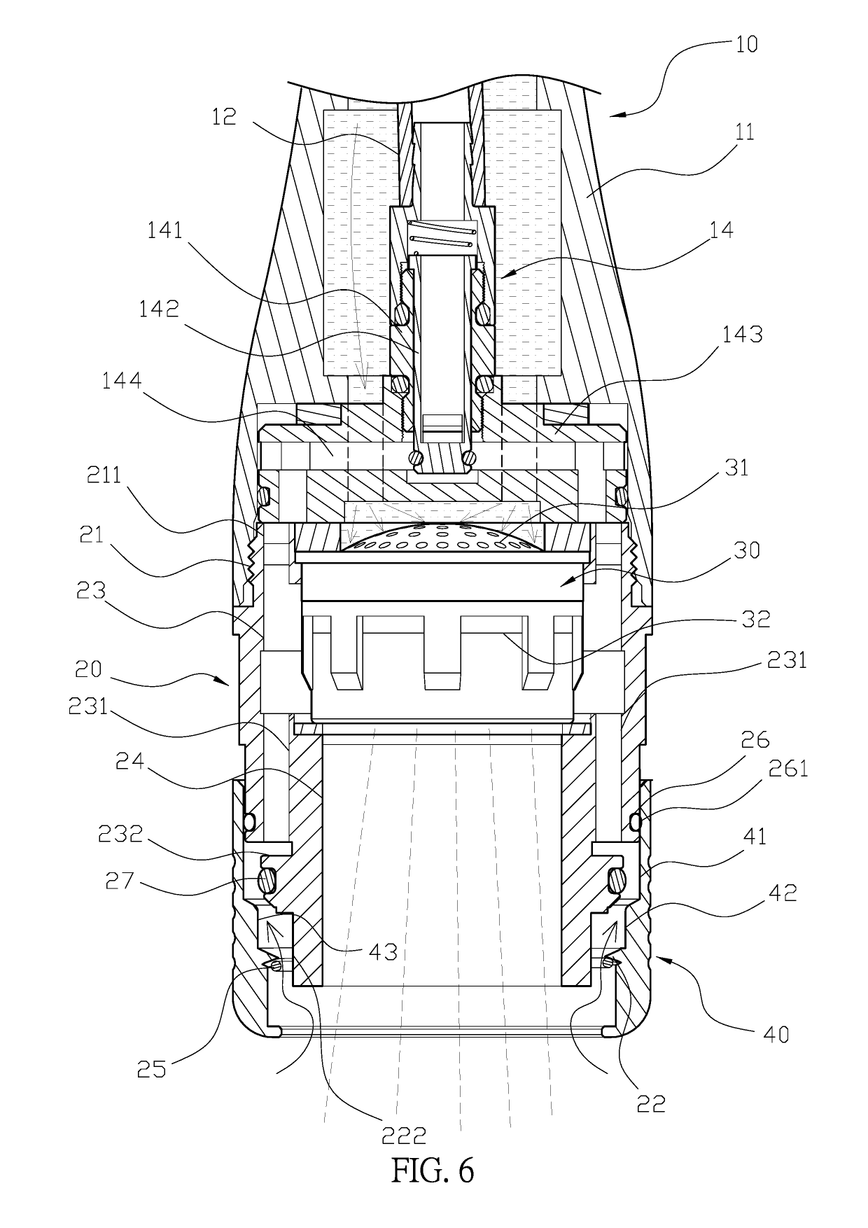

In actual application, referring to FIGS. 2 to 4, the guiding tube (12) connected to the ozonizer (13) is settled inside the water outlet tube (11) of the faucet (10), and the valve tube (141) of the check valve (14) is connected to the guiding tube (12). Then, the bubbler (30) is secured inside the upper opening (23) of the connecting unit (20). By bearing the lateral surface of the bubbler (30) against the upper opening (23) of the connecting unit (20), the lateral openings (32) of the bubbler (30) are communicated with the through hole (211) and the vent (231) of the connecting unit (20). Then, the connecting unit (20) is connected to a lower opening of the water outlet tube (11) through the fixing portion (21), so that the through hole (211) of the connecting unit (20) is communicated with the flowing channel (144) of the check valve (14) and the bubbler (30) is communicated with the water outlet tube (11) through the pores (31). The elastic ring (261) is disposed in the first annular groove (26) of the connecting unit (20), and the control sleeve (40) is connected to the connecting unit (20) by engaging the first threaded segment (22) with the second threaded segment (42). Thus, the elastic ring (261) is borne against the first surface (41) of the control sleeve (40), and the sealing ring (27) is borne against the second surface (43) of the control sleeve (40). Furthermore, the engaging unit (25) is received in the locating annular groove (221) of the connecting unit (20) to block the second threaded segment (42) thereby preventing the control sleeve (40) from detaching from the control unit (20). Through the engagement between the second threaded segment (42) and the first threaded segment (22), a user can turn the control sleeve (40) to adjust relative positions between the control sleeve (40) and the connecting unit (20) thus controlling on/off operation and the amount of the ozone. When a user needs to mix the ozone with water, the control sleeve (40) is turned to allow the second threaded segment (42) to move along the first threaded segment (22) of the connecting unit (20), and the elastic ring (261) and the sealing ring (27) are respectively located at positions to block the bore (232) of the connecting unit (20). As a result, the upper opening (23) is only communicated with the lower opening (24), and water flowing through the pores (31) into the bubbler (30) is scattered into droplets which are easily to mix with the air. Then, when water flows downwardly to lower opening (24), the lateral openings (32) of bubbler (30) generates a siphon effect to allow the ozone to flow through the guiding tube (12), the check valve (14) and the through hole (211) into the lateral openings (32) and to allow the ozone well mixes with the water through negative pressure. When a user only needs tap water, referring to FIGS. 5 and 6, the control sleeve (40) is pulled to move away from the connecting unit (20), so that the bore (232) are not blocked by the control sleeve (40) and the sealing ring (27) is not borne against the control sleeve (40). Meanwhile, the bore (232) of the connecting unit (20) and the vent (231) are communicated with the air outside the faucet (10). As a result, the siphon effect is generated when water flows through the lateral openings (32) of the bubbler (30), and since a pressure at the vent (231) is lower than a pressure at the guiding tube (12), the ozone is not driven by negative pressure to flow into the faucet (10) and the water is only mixed with the air flowing into the faucet (10) through the vent (231). With the design of the control sleeve (40), the ozone from the ozonizer (13) can be easily and safely operated to mix water of the faucet (10).

More specifically, referring to FIGS. 2 to 6, the bore (232) of the connecting unit (20) is located between the elastic ring (261) and the first threaded segment (22), and at least one plane venting surface (222) is formed on the first threaded segment (22). When a user only needs tap water, the control sleeve (40) is turned to move away from the connecting unit (20), and the air flows between the connecting unit (20) and the control sleeve (40) into the vent (231) thus replacing the ozone to mix with water. Moreover, the control sleeve (40) is connected with the connecting unit (20) by engaging the second threaded segment (42) with the first threaded segment (22). By turning the control sleeve (40) to adjust the relative positions between the control sleeve (40) and the connecting unit (20), the present invention can prevent the control sleeve (40) from being moved by water flow or airflow and can accurately control the use of the ozone thus improving the practicability thereof.

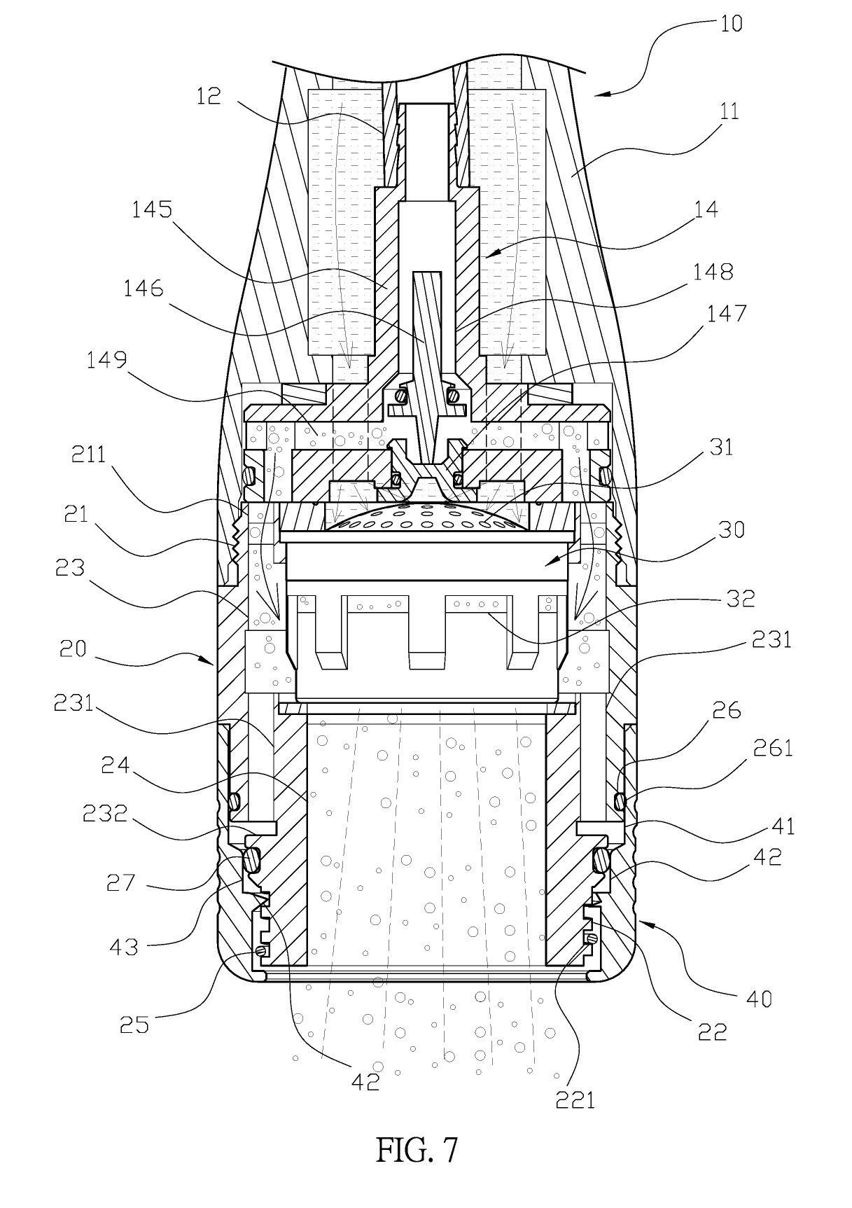

In another embodiment, referring to FIG. 7, the check valve (14) comprises a valve base (145), a second valve core (146) and a second valve pocket (147). An upper end of the valve base (145) is connected to the guiding tube (12) while a lower end thereof is borne against the bubbler (30), and a central hole (148) penetrates through the valve base (145). Also, an interior space of the valve base (145) has a second flowing channel (149) which is communicated with the through hole (211) of the connecting unit (20). The second valve core (146) is received in the central hole (148) of the valve base (145), and the second valve pocket (147) couples on the central hole (148) to limit a position of the second valve core (146). Through the second valve core (146), the check valve (14) is configured to allow fluid to flow in the second flowing channel (149) in only one direction.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A faucet apparatus comprising:
a faucet having a water outlet tube, and a guiding tube settled inside an interior space of the faucet, and a first end of the guiding tube connected to an ozonizer;
a connecting unit comprising a fixing portion and a first threaded segment respectively formed at an upper and a lower end thereof, and a through hole vertically penetrating through an inner edge of the fixing portion of the connecting unit; the connecting unit connected to the water outlet tube through the fixing portion to allow the guiding tube to communicate with the first through hole, and a locating annular groove, which is formed at a lower end of the first threaded segment, configured to receive a C-shaped engaging unit therein; an upper opening and a lower opening, which are communicated with each other, vertically and respectively penetrate through an upper portion and a lower portion of the connecting unit, and the upper opening further communicated with the through hole; an inner wall of the upper opening having at least a vertical vent which is extended downwardly toward an inner wall of the lower opening, and a bore, which penetrates through an outer surface of the connecting unit, communicated with the vent; the outer surface of the connecting unit further comprising at least a first annular groove located near the bore, and an elastic ring disposed in the first annular groove; the bore located between the elastic ring and the first threaded segment, and a sealing ring disposed on the outer surface of the connecting unit between the bore and the first threaded segment;
a bubbler secured on the upper opening of the connecting unit, and a top surface of the bubbler communicated with the water outlet tube of the faucet through a plurality of pores which are configured to produce a splashing stream of water, and a plurality of lateral openings penetrating through a lateral surface of the bubbler such that the through hole, the vent, the upper opening, the pores and the lower opening configured to communicate with each other; and
a control sleeve covering around an outer periphery of the lower opening of the connecting unit, and a first surface, which is formed at an upper portion of an inner surface of the control sleeve, borne against the elastic ring to create an air-tight seal; a second threaded segment, which is formed at a lower portion of the inner surface of the control sleeve, configured to engage with the first threaded segment of the control unit to adjust relative positions between the control sleeve and the connecting unit; a second surface located between the first surface and the second threaded segment, and the sealing ring borne against the second surface to achieve an air-tight effect.

2. The faucet apparatus of claim 1, wherein at least a plane venting surface is formed on the first threaded segment of the connecting unit to allow a large amount of air outside the faucet to enter the vent of the upper opening through a space between the venting surface and the control sleeve.

3. The faucet apparatus of claim 1, wherein a check valve connected between the through hole of the connecting unit and the guiding tube is configured to allow fluid to flow through the check valve in only one direction.

4. The faucet apparatus of claim 3, wherein the check valve comprises a valve tube, a first valve core and a first valve pocket, and a first end of the valve tube is connected to the guiding tube while a second end thereof is connected to the first valve pocket, and a first flowing channel formed inside the first valve pocket is communicated with the valve tube and the through hole of the connecting unit, and the first valve core located inside the valve tube is configured to allow fluid to flow in one direction.

5. The faucet apparatus of claim 3, wherein the check valve comprises a valve base, a second valve core and a second valve pocket, and a first end of the valve base is connected to the guiding tube while a second end thereof is borne against the bubbler; a central hole penetrates through the valve base, and an interior space of the valve base has a second flowing channel which is communicated with the through hole of the connecting unit; the second valve core is received in the central hole, and the second valve pocket couples on the central hole to limit a position of the second valve core thereby allowing fluid to flow in one direction.
